(19) United States
(12) Patent Application Publication
(10) Pub. No.: US 2005/0038781 A1
(43) Pub. Date: Feb. 17, 2005

(54) Method and system for interpreting multiple-term queries

(75) Inventors: Adam J. Ferrari, Cambridge, MA (US); Daniel Tunkelang, New York, NY (US)

Correspondence Address: WILMER CUTLER PICKERING HALE AND DORR LLP, 60 STATE STREET, BOSTON, MA, 02109, US

(73) Assignee: Endeca Technologies, Inc., Cambridge, MA (US)

(21) Appl. No.: 10/657,426

(22) Filed: Sep. 8, 2003

Related U.S. Application Data
(63) Continuation-in-part of application No. 10/317,337, filed on Dec. 12, 2002.

(51) Int. Cl. G06F 17/30

(52) U.S. Cl. 707/4

(57) ABSTRACT

A query interpretation method and system uses a combination of context-independent and contextual evaluation to compute interpretations for multiple-term queries. The present invention can be used to search a collection of items, each of which is associated with one or more terms. In certain embodiments, query interpretation involves generating several candidate multiple-term interpretations and scoring them to select one or more interpretations. In certain embodiments, query interpretation involves identifying single-term interpretations for the terms in the query, determining context-independent scores for those single-term interpretations, pruning candidate single-term interpretations, identifying a plurality of candidate multiple-term interpretations, determining a contextual score for each candidate multiple-term interpretation, which may involve using different semantic approaches, and generating one or more multiple-term interpretations that are optimal with respect to a combination of the context-independent and contextual scoring functions.

### RELATED APPLICATIONS

This application is a continuation-in-part of co-pending application Ser. No. 10/317,337, entitled “Method and System for Interpreting Multiple-Term Queries,” filed Dec. 12, 2002, by Daniel Tunkelang and Adam J. Ferrari, and having the same assignee as the present application.

### FIELD OF THE INVENTION

The present invention relates to information searching and retrieval, and more specifically, relates to methods for processing search queries.

### BACKGROUND OF THE INVENTION

Many database systems allow users to retrieve information, and, in particular, identify items of interest to the user from a collection of items, using a search interface. For example, Google™ allows users to query its database of World Wide Web content by entering one or more search terms. Online retailers like Amazon™ similarly allow users to access their product catalogs using search interfaces. The use of search functionality is by no means restricted to the World Wide Web or to online services in general; database systems with search interfaces are ubiquitous.

One method for performing a search through a search interface is by entering one or more search terms. One challenge in implementing search interfaces is correctly interpreting the user's query, since there may be multiple ways of interpreting the query. If the user has entered the query by typing in the search terms, the user may have misspelled one or more terms in the query. As a result, the search interface may not identify the items desired by the user in the search results. Similarly, if the user has entered the query by selecting terms from a list of options presented by the search interface, the user may have selected a similar term in place of a desired term, leading to the same result. If a user query includes the term applet it is possible that the user actually intended the computer science term applet but it is also possible that the user misspelled the term apple. In interpreting the query, one option is to take the uncommon word applet at face value, while another option is to treat it as a misspelling of the more common word apple. The plausibility of each interpretation is likely to depend on the nature of the data being queried, e.g., applet is more plausible in the context of a technical knowledge base than in the context of a supermarket inventory.

Spelling errors are just one type of issue in query interpretation. Semantic interpretation poses a more subtle challenge than spelling correction. For example, notebook may be interpreted as meaning a composition book or a laptop computer. Again, the plausibility of each interpretation is likely to be data-dependent. Similarly, the text string sei may interpreted as the Italian word meaning “you are” or may correspond to one of numerous organizations abbreviated as SEI.

When there is only a single query term, the process of query interpretation generally includes the following steps: First, candidate interpretations are generated by applying syntactic rules, thesaurus expansion, and any other available resources. Then, these candidate interpretations are scored based on costs associated with the query transformation (e.g., the number of characters inserted or removed from the original query term) and a data-driven score for the candidate (e.g., the number of documents that would be returned for that search). The scores are used to select an interpretation.

When there are multiple query terms, the process of query interpretation is more complicated. One approach is to interpret each query term independently and substitute the interpretation into the query. This approach, however, fails to consider the importance of context. For example, in a general document collection, the query peerl necklace should probably be interpreted as pearl necklace, while the query peerl compiler should probably be interpreted as perl compiler. Interpreting each word independently loses the contextual information.

Another approach makes some use of context by first identifying the query terms found in the database and then replacing the remaining terms with replacement terms that are found in a table of terms related to those that were found in the database and spelled similarly. A problem with this and related approaches is that they introduce an artificial asymmetry between matching and non-matching terms. In effect, the matching terms are given greater weight than the non-matching terms. Consider the following 4 queries:

| Query | Matching Terms | Non-Matching Terms |
|---|---|---|
| perl necklace | perl, necklace | |
| peerl necklace | necklace | Peerl |
| perl necklac | Perl | Necklac |
| prl necklac | | prl, necklac |

In all 4 cases, the right interpretation is probably pearl necklace. The previously described approach would have probably resulted in this interpretation for the second case peerl necklace (since necklace matches and presumably has pearl as a related word that could be used to replace peerl) but not for the other 3 cases.

### SUMMARY OF THE INVENTION

The present invention is directed to a query interpretation method and system that uses a combination of context-independent and contextual evaluation to compute interpretations for multiple-term queries. The present invention can be used to search a collection of items, each of which is associated with one or more terms. In certain embodiments, query interpretation involves generating several candidate multiple-term interpretations and scoring them to select one or more interpretations. In certain embodiments, query interpretation involves identifying single-term interpretations for the terms in the query, determining context-independent scores for those single-term interpretations, identifying a plurality of candidate multiple-term interpretations, determining a contextual score for each candidate multiple-term interpretation, and generating one or more multiple-term interpretations that are optimal with respect to a combination of the context-independent and contextual scoring functions.

It is contemplated that embodiments of the invention may be useful for addressing different types of query interpretation issues, including misspelling, incorrect spacing of words in the query, inadvertent substitution of one legitimate search term for another, etc. The invention is not limited to correcting obvious spelling errors. In some embodiments, optimal multiple-term interpretations may include replacement terms for terms that were matching terms in the original query. Accordingly, the invention may be useful even when the original query obtains a non-empty result.

The invention has broad applicability and is not limited to certain types of items or terms. For example, in some applications, items may be text documents, such as news articles or genome sequences, and terms may be words, phrases, or other character strings. In other applications, the items may represent numerical data and terms may be numbers or sequences of digits. The invention in broadly applicable to items and terms that can be represented as sequences of characters.

In some embodiments of the present invention, some items may be represented by structured records. For such records, the fields might be referenced by search queries, while unstructured records may be treated as a single field. For example, a news article may have various fields corresponding to the title, author, date, and article text associated with it. In such embodiments, the query interpretation process may take these fields into account. For example, an interpretation whose terms occur in the title of a news article in the collection may receive a higher score than an interpretation whose terms occur only in the text of a news article in the collection or across multiple fields.

The query processing approach of the present invention permits the use of contextual information when interpreting multiple-term queries. This approach can also be used to avoid introducing an asymmetry between matching and non-matching terms. Generally, the present invention serves to improve search interfaces to information databases.

A query processing system in accordance with the present invention implements the method of the present invention. In exemplary embodiments of the invention, the system processes a query entered by a user relative to a collection of items contained within a database in which each item is associated with one or more terms. In such embodiments, the system preferably responds to the user query with one or more candidate interpretations of the user's query.

In some embodiments of the present invention, the query processing system is a subsystem of an information retrieval application. In such embodiments, the candidate interpretations of a user query may be used to transform the user's query, or to suggest possible variations of the user's query.

### BRIEF DESCRIPTION OF THE DRAWINGS

The invention may be further understood from the following description and the accompanying drawings, wherein:

FIG. 1 is a flow diagram that illustrates a method for interpreting multiple-term queries in accordance with one embodiment of the invention.

### DETAILED DESCRIPTION OF THE PREFERRED EMBODIMENTS

The present invention is directed to a system and method for generating interpretations for multiple-term queries submitted to a search interface for retrieving information from a database. The system may use uses a combination of context-independent and contextual evaluation to generate interpretations for multiple-term queries relative to the database being searched. The items in the database may be, for example, news articles, product descriptions, genome sequences, and time-series data. The collection need not be limited to a uniform type of item, but could be a combination of different types of items. For example, on a World Wide Web-based shopping site, the database may be a product database that includes product descriptions of a number of different types of products, product reviews, product selection guides, etc.

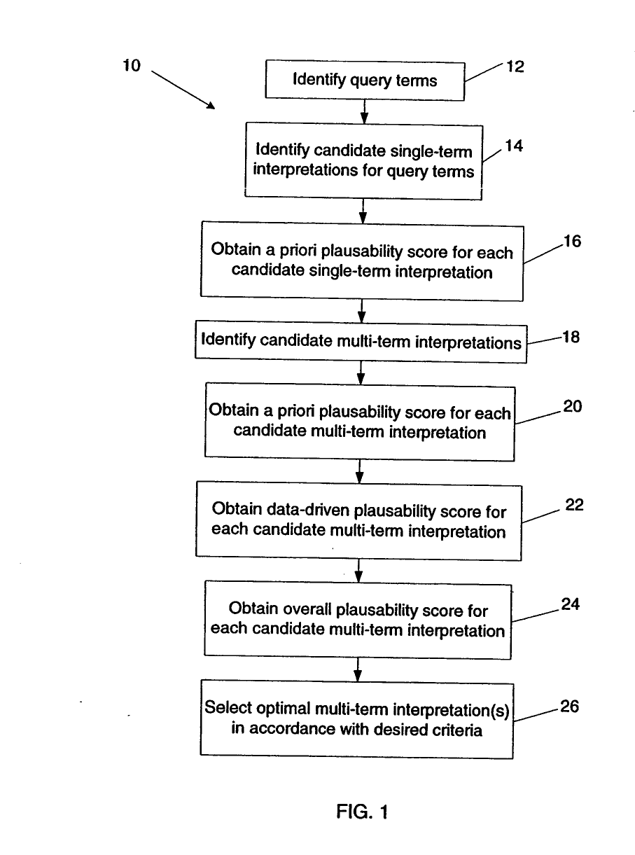

A method 10 for processing a multiple-term query in accordance with one embodiment of the invention is illustrated in the flow diagram of FIG. 1. The method may be implemented, for example, by a query processing system in an information retrieval system. The embodiments described herein for purposes of illustration include a database of apparel product descriptions, in which the items are unstructured English text documents, unless otherwise stated.

A query is generally composed by a user typing in one or more terms. The terms may be entered, for example, in the form of a grammatical expression, a Boolean expression, or in accordance with the rules of a special search language. Depending on how the query is entered, an initial step 12 may be to identify the terms in the query, which can be done in a number of ways. In some embodiments, a special separator character is used to explicitly separate distinct query terms. In other embodiments, the separation of terms may be implicit, determined by rules or even guessed heuristically. In other embodiments, term extraction may require a more involved process, including tokenization or other parsing steps.

In the embodiments described herein, by way of example and not of limitation, a query is composed of terms that are English words or phrases, and the terms are separated by the comma (,) character, a special separator character that cannot occur within a term. For example, in the context of a database where items correspond to apparel product descriptions, the following are sample queries:
shoes
athletic, socks
white, athletic socks
Tomy Hilfinger, jean
navyblue, sweat, pants

The present invention can be used to process multiple-term queries that include any combination of correctly and incorrectly entered terms. Some terms may be overtly misspelled (e.g., they do not match any word in a dictionary or in an item in the database). As shown in FIG. 1, one step 14 in interpreting a query is to identify candidate single-term interpretations for the terms in the query. Although in certain embodiments, this step 14 may be limited to terms that are overtly misspelled or otherwise suspected of being entered incorrectly, it can also be applied to terms that appear to be and have been entered correctly by the user. Each single-term interpretation applies to part of the query—typically a single word, though possibly a phrase—and thus may fail to take advantage of the context provided by the rest of the query.

Once the query terms have been extracted from the query, they form the basis for identifying candidate single-term interpretations. Candidate single-term interpretations can be generated from the query terms in various ways. In some embodiments, the query terms themselves may be identified as candidate single-term interpretations. This case represents the simplest process of interpretation for a single term. In some embodiments, candidate single-term interpretations may be generated by applying editing operations to query terms, or to other candidate single-term interpretations. Editing operations include character substitution (e.g., khakys to khakis), character deletion (e.g., khakies to khakis), character insertion (e.g., kakis to khakis), and character transposition (e.g., kahkis to khakis).

In some embodiments, candidate single-term interpretations may be generated by splitting a query term, or another candidate single-term interpretation, into multiple candidate single-term interpretations (e.g., combatboots→combat, boots). In some embodiments, candidate single-term interpretations may be generated by combining query terms, or other candidate single-term interpretations, into a single candidate single-term interpretation (e.g., sweat, pants→sweatpants).

In some embodiments, candidate single-term interpretations may be generated by applying syntactic transformations to query terms, or to other candidate single-term interpretations. One class of syntactic transformations is grammatical inflection (e.g., jean→jeans). Generally, syntactic transformations involve rules for rewriting terms that are independent of semantics.

In some embodiments, candidate single-term interpretations may be generated by applying phonetic transformations to query terms, or to other candidate single-term interpretations (e.g., genes to jeans). Soundex coding is an example of phonetic transformation.

In some embodiments, candidate single-term interpretations may be generated by using a thesaurus to find variants of query terms, or of other candidate single-term interpretations (e.g., slacks to pants). Such a thesaurus might contain general content (e.g., Roget's Thesaurus) or content specific to an application domain (e.g., a context thesaurus built by analyzing the database for statistically significant word or phrase co-occurrences).

In the embodiments described in detail herein, candidate single-term interpretations includes the terms themselves and interpretations that are generated by applying editing operations or substitution, deletion, insertion, and transposition to query terms. In certain embodiments, the set of possible interpretations is limited by setting a maximal number of operations that can be performed to generate candidate single-term interpretations, e.g., a maximum of 2 edit operations per term.

The above examples represent some of the possible ways in which candidate single-term interpretations can be generated from the query terms and are described by way of example only. Other methods could also be used to generate candidate single-term interpretations from the query terms in embodiments of the present invention.

In some embodiments of the present invention, a candidate single-term interpretation is associated with a context-independent score. As shown in FIG. 1, the step 16 of generating a context-independent score succeeds identifying candidate single-term interpretations indicated in step 14; however, this step 16 could also occur concurrently with step 14. The context-independent score of a candidate single-term interpretation measures its plausibility independent of the context supplied by the other terms of the query.

Various factors may contribute to the plausibility of a candidate single-term interpretation. Two general considerations are how close the interpretation is to the query term used to generate it, and the likelihood of the interpretation considered independently of the query.

All else being equal, a single-term interpretation that is closer to the query term should be more plausible than an interpretation that is further from it. For example, if the query term is nigt, then night is generally a closer interpretation than knight or evening. In general, the plausibility measure should favor less aggressive interpretations over more aggressive interpretations.

At the same time, some single-term interpretations may be, considered independently of the query, more plausible than others. For example, a technical knowledge base may contain many more documents about the perl programming language than about pearls. Hence, in such a context, perl is likely to be a more plausible interpretation than pearl, independent of the other terms in the query.

These two considerations may be in conflict with one another. In the last example, if the query term is pearl, then pearl is a closer interpretation than per, but perl is likely to be more plausible independent of the query. Hence, the plausibility measure must trade off these two potentially conflicting considerations.

Depending on the scoring metric, it is possible that either higher or lower scores correspond to more plausible context-independent interpretations. It will be assumed, without any loss of generality, that a lower score corresponds to a more plausible context-independent interpretation.

For example, consider the query tiet, pints. In certain embodiments, the candidate single-term interpretations of each term are tiet, tie, and tight (from tiet); and pints, pins, and pants (from pints). The context-independent scores for these candidate single-term interpretations are computed without considering the plausibility of possible combinations like tie, pins and tight, pants.

In some embodiments, context-independent scores for candidate single-term interpretations may be based on their edit distances from corresponding query terms. The various editing operations (e.g., substitution, deletion, insertion, transposition) may contribute equally to the scoring function, or may be weighted differently (e.g., a substitution may contribute 2 to the score, while a transposition may only contribute 1).

In an example embodiment, the context-independent score for a candidate single-term interpretation is equal to the edit distance between the candidate single-term interpretation and the query term from which it was generated. The edit distance is measured as the total number of it operations applied to the query term to generate the candidate single-term interpretation. For example, the edit distance between blleu and blue is 2, since there is one deletion and one transposition.

In some embodiments, context-independent scores for candidate single-term interpretations may be based on the syntactic or phonetic transformations used to generate them. For example, if the candidate single-term interpretation jeans is generated by inflecting the query term jean, the context-independent score could be based on an empirically determined probability that a user would enter a singular form intending the plural form.

In some embodiments, context-independent scores for candidate single-term interpretations may be based on the strength of semantic or statistical relationships when a thesaurus is used to generate them. For example, if the candidate single-term interpretation “slacks” is obtained from a thesaurus because it is related to the query term “pants,” the context-independent score could be based on the strength associated with the relationship between “slacks” and “pants.” This relationship may be symmetric (i.e., “slacks” may imply “pants” to the same degree that “pants” implies “slacks”) or asymmetric, depending on the nature of the thesaurus.

In some embodiments, the context-independent scores for a candidate single-term interpretation may be based on the number of items associated with that candidate single-term interpretation. For example, if sweatpants and sweaters are both candidate single-term interpretations for the query term sweats, and the latter is associated with more items in the database, then it may be assigned a higher context-independent score. The number of items is an example of more general quality-of-results measures that may be used to determine the context-independent score for a candidate single-term interpretation. For example, the items may be weighted according to their importance, or the associations themselves may be weighted, e.g., association with a product name may be more significant than association with a product description.

The above examples represent some of the possible factors that may contribute to the context-independent scores for candidate single-term interpretations. Other methods for computing these context-independent scores could also be used, and various factors can be combined to generate the context-independent scores. Factors defined in numerical terms may be combined using, for example, addition, multiplication, or other arithmetic operations. The scores may be used to select candidate single-term interpretations from a set of possible interpretations.

After the candidate single-term interpretations have been identified as indicated in step 16, they are combined to create candidate multiple-term interpretations in step 18. The sequence shown in FIG. 1 is only one example; although in some embodiments, it may be necessary for step 16 to precede step 18, in other embodiments, the step of identifying candidate multiple-term interpretations is not dependent on the step of assigning context-independent scores to the single-term interpretations.

In some embodiments, some candidate multiple-term interpretations are generated by including a candidate single-term interpretation corresponding to each of the query terms. For example, if the query is bleu, shirt, and the candidate single-term interpretations include blue (corresponding to bleu) and shirts (corresponding to shirt), then blue, shirts may be generated as a candidate multiple-term interpretation.

In some embodiments, some candidate multiple-term interpretations are generated by including candidate single-term interpretations corresponding to only a subset of the query terms. For example, if the query is trendy, lether, bags, and the candidate single-term interpretations include leather (corresponding to lether) and handbags (corresponding to bags), then leather, handbags may be generated as a candidate multiple-term interpretation.

In some embodiments, certain potential candidate multiple-term interpretations may be eliminated from consideration because they do not correspond to a large or significant enough subset of the query terms. For example, if the query is trendy, lather, bags, then the candidate multiple-term interpretations might include trendy, leather, handbags and trendy, handbags and leather, handbags, but exclude the interpretations lather and leather, each of which corresponds to a single term of the query, because they do not correspond to a sufficient fraction of the query terms. The determination of whether a subset of the query terms is sufficient to generate an acceptable candidate multiple-term interpretation might take into account the size of the subset (e.g., by requiring that a certain fraction of the query terms be covered), or take into account the significance of specific terms in the query (e.g., by using a weighted sum reflecting individual term weights based on how common the terms are), or some other measure.

In some embodiments, candidate multiple-term interpretations are generated by taking all possible combinations of candidate single-term interpretations that include exactly one candidate single-term interpretation per query term. For example, if the query is bleu, jean, and the candidate single-term interpretations are bleu, blue, and blues (for bleu) and jean and jeans (for jean), then the candidate multiple-term interpretations are the 6 possible combinations: bleu, jean; bleu, jeans; blue, jean; blue, jeans; blues, jean; and blues, jeans. For example, if the query is dresss, short, and the candidate single-term interpretations include dress and dresses (corresponding to dresss); and shirt, short, and shorts (corresponding to short), then the following six combinations may be generated as candidate multiple-term interpretations: dress, shirt; dress, short; dress, shorts; dresses, shirt; dresses, short; and dresses, shorts.

In some embodiments, candidate multiple-term interpretations include a subset of the possible combinations of the identified candidate single-term interpretations for each query term. In the previous example involving bleu, jean, in such an embodiment, it is possible that not all of the six combinations are generated as candidate multiple-term interpretations.

In some embodiments, all possible combinations of candidate single-term interpretations are used to generate the set of all possible multiple-term interpretations. In some embodiments, the combinations are constrained so that each query term is represented at most once in a candidate multiple-term interpretation. In some embodiments, the combinations are constrained so that each query term is represented exactly once in a candidate multiple-term interpretation.

In some embodiments, a pruning phase eliminates candidate single-term interpretations from consideration. As a result, the pruning phase may reduce the number of candidate multiple-term interpretations that are generated and improve the efficiency of the query interpretation process.

In some such embodiments, candidate single-term interpretations are eliminated if they have no or few associated items in the database. In one example embodiment, each of n query terms {q₁, q₂, . . . , qₙ} is associated with k candidate single-term interpretations {i₁₁, i₁₂, . . . , i₁ₖ, i₂₁, i₂₂, . . . , i₂ₖ . . . iₙ₁, i₁₂, . . . , iₙₖ}, resulting in kⁿ candidate multiple-term interpretations that correspond to combinations of single-term interpretations (in this example embodiment multiple-term interpretations are required to account for all n query terms).

In this embodiment, a query Q that is a conjunction of disjunctions is generated: Q=(i₁₁ OR i₁₂ OR . . . OR i₁ₖ) AND (i₂₁ OR i₂₂ OR . . . OR i₂ₖ) AND . . . AND (iₙ₁ OR iₙ₂ OR . . . OR iₙₖ). The result of this query Q includes all of the items in the database that contain any of the candidate single-term interpretations. These are all of the items in the database that may potentially be identified as responsive to the original query based on the candidate single-term interpretations that have been generated. This query Q is logically equivalent to the union of all of the kⁿ candidate multiple-term interpretations, but can be evaluated in time proportional to kn, rather than to kⁿ. For example, if k=10 and n=3, then kn=30, while kⁿ=1000. This reduced number of items can then be used to determine which of the kn candidate single-term interpretations yield a suitable number of results to merit inclusion in the candidate multiple-term interpretations. Accordingly, kn intersection queries are generated to determine whether each candidate single-term interpretation matches a sufficient number of items in the result of Q: i₁₁ AND Q, i₁₂ AND Q, . . . , iₖₙ AND Q. The intersection queries that return no results, or whose result set size is below some threshold, can be used to eliminate the corresponding candidate single-term interpretations from consideration. This pruning approach can eliminate at an early stage single-term interpretations that would otherwise generate multiple-term interpretations with few or no results.

This technique has been described by way of example for the case in which each of kⁿ candidate multiple-term interpretations corresponds to a conjunction of candidate single-term interpretations, and in which each multiple-term interpretation is required to account for all n query terms. The technique is not restricted to this case, but generalizes to embodiments in which multiple-term interpretations do not necessarily correspond to conjunctions, in which individual multiple-term interpretations do not necessarily account for all n query terms, and in which not all possible candidate multiple-term interpretations are being considered. In general, this technique potentially reduces a problem whose size is exponential in n to one that is linear in n, and may thus achieve significant efficiency gains.

In some embodiments, a search or optimization algorithm is used to generate a subset of the possible multiple-term interpretations. Such an algorithm is used to efficiently produce multiple-term interpretations with good overall scores.

In some embodiments, candidate multiple-term interpretations are generated using a greedy algorithm. A greedy algorithm builds a candidate multiple-term interpretation by adding candidate single-term interpretations one at a time to the combination, choosing at each step the single-term interpretation that is locally optimal for the overall score.

In some embodiments, candidate multiple-term interpretations are generated using a best-first search algorithm. A best-first search algorithm maintains a priority queue of candidate multiple-term interpretations and, at each step, greedily adds a candidate single-term interpretation to the candidate in the priority queue with the best score. The best-first search algorithm may be run until it enumerates all candidates, or it may be terminated sooner for the sake of efficiency.

The above examples represent some of the possible search or optimization algorithms for efficiently producing multiple-term interpretations with good overall scores. Their enumeration in no way rules out the use of other algorithms for computing these multiple-term interpretations. Other algorithms include branch-and-bound and dynamic programming.

In embodiments of the present invention, a candidate multiple-term interpretation is associated with a context-independent score, obtained as indicated in step 20. The context-independent score of a candidate multiple-term interpretation measures its plausibility by considering each candidate single-term interpretation that composes it independently of the other candidate single-term interpretations. Depending on the scoring metric, it is possible that either higher or lower scores correspond to more plausible context-independent interpretations. It will be assumed, without any loss of generality, that a lower score corresponds to a more plausible context-independent interpretation.

The context-independent score for a candidate multiple-term interpretation is determined by combining the context-independent scores for the candidate single-term interpretations that were combined to generate it. In some embodiments, the context-independent score for a candidate multiple-term interpretation is determined by adding the context-independent scores for the candidate single-term interpretations that were combined to generate it. In some embodiments, the context-independent score for a candidate multiple-term interpretation is determined by multiplying the context-independent scores for the candidate single-term interpretations that were combined to generate it. In an example embodiment, the context-independent score for a candidate multiple-term interpretation is equal to the sum of the context-independent scores for the candidate single-term interpretations that were combined to generate it. For example, if the query is bleu, jean, then the candidate multiple-term interpretation blue, jeans has a context-independent score of 2 (1 transposition from bleu to blue; 1 insertion from jean to jeans).

The above-described computations represent some of the possible ways of combining context-independent scores for candidate single-term interpretations to obtain a context-independent score for a candidate multiple-term interpretation. Any function that generates a score indicative of the plausibility of the interpretations using the context-independent scores for the candidate single term interpretations that compose the interpretations can be used. The factors may be combined using, for example, addition, multiplication, or other arithmetic operations.

In embodiments of the present invention, a candidate multiple-term interpretation is also associated with a contextual score. In the embodiment illustrated in FIG. 1, step 22 is directed to obtaining a contextual score for each candidate multiple-term interpretation. This contextual score of a candidate multiple-term interpretation measures its plausibility relative to the database of items. In some embodiments, the contextual score is independent of how it was generated from the query. Depending on the scoring metric, it is possible that either higher or lower scores correspond to more plausible contextual interpretations. It will be assumed, without any loss of generality, that a higher score corresponds to a more plausible contextual interpretation.

In some embodiments, contextual scores for candidate multiple-term interpretations may be based on the number of items associated with that candidate multiple-term interpretation. For example, if tight, pants and tight, pins are both candidate multiple-term interpretations, and the former is associated with more items in the database, then it may be assigned a higher contextual score. The number of items is an example of more general quality-of-results measures that may be used to determine the contextual score for a candidate multiple-term interpretation. For example, the items may be weighted according to their importance, or the associations themselves may be weighted, e.g., multiple terms that occur as a phrase in a product description may be more significant than multiple terms that appear separately in a product description.

In an example embodiment, the contextual score for a candidate multiple-term interpretation is equal to the number of items associated with that candidate multiple-term interpretation. In the example embodiment, an item is associated with a candidate multiple-term interpretation if all of the terms in that interpretation occur in the text associated with that item. For example, if 30 items contain both the word tight and the word pants, then the candidate multiple-term interpretation tight, pants has a contextual score of 30.

In some embodiments, the contextual evaluation is based on treating a multiple-term interpretation as a conjunction of terms. In certain embodiments that treat a multiple-term interpretation as a conjunction, an item is associated with a multiple-term interpretation if it is associated with ail of the terms in that interpretation. For example, a conjunctive interpretation of blue jeans associates with that interpretation items that contain both words. In some embodiments, the contextual evaluation is based on treating multiple-term interpretations as disjunctions of terms. In certain embodiments that treat a multiple-term interpretation as a disjunction, an item is associated with a multiple-term interpretation if it is associated with any of the terms in that interpretation. For example, a disjunctive interpretation of blue jeans associates with that interpretation items that include either word.

In some embodiments, the contextual evaluation is based on treating a multiple-interpretation as neither a strict conjunction nor a strict disjunction. For example, an item may be associated with a multiple-term interpretation if it is associated with the majority of the terms in that interpretation. In another example, an item may be associated with a multiple-term interpretation if it is associated with the high-information (e.g., infrequent) terms in the interpretation. In certain embodiments, a query processing system may use Boolean logic, information-based predicates, and term proximity predicates (e.g., blue NEAR jeans) to determine which items are associated with a multiple-term interpretation.

In some embodiments, there may be multiple semantic approaches for determining which items in the database are associated with a particular candidate multiple-term interpretation. The size of the result set for a candidate multiple-term interpretation will vary depending on the semantic approach that is used. For example, using disjunctive semantics for determining which items match a candidate multiple-term interpretation will often lead to a larger associated item set than using conjunctive semantics. Partial match semantics, e.g., considering an item to be in a candidate multiple term interpretation's associated item set if it matches a sufficient fraction of the terms in that interpretation generally falls between disjunctive and conjunctive semantics. The particular semantic approach that is applied can affect the contextual score because the number of associated items in the result set for a candidate multiple-term interpretation is an important factor in the contextual score in certain embodiments. In some embodiments, the type of semantic approach used is itself factored into the contextual score for a candidate multiple-term interpretation. In some embodiments, the number of terms from a candidate multiple-term interpretation matched in the items in the result set or some other information measure reflective of the semantic approach used may be the dominant factor in determining the contextual score. For example, in an embodiment in which partial matching can be used to determine a contextual score for a candidate multiple term interpretation, a rule can be implemented such that combinations that match a maximal number of terms in the candidate multiple-term interpretation are preferred over those that match fewer terms but return more associated results in the database

In some embodiments, the semantic approach used to determine which items are associated with a particular candidate multiple-term interpretation is selected in such a way as to maximize its contextual score. For example, if a candidate multiple-term interpretation could be considered using either conjunctive or disjunctive semantics, the semantics that result in the higher contextual score could be preferred.

In embodiments of the present invention, a candidate multiple-term interpretation is associated with a both a context-independent and a contextual score. As indicated in step 24, these scores are combined to obtain an overall score for the candidate multiple-term interpretation.

The context-independent and contextual scores can be combined in a number of ways to generate an overall score that is indicative of the plausibility of the interpretation. In some embodiments, the context-independent and contextual scores are combined using addition or subtraction. For example, the overall score for a candidate multiple-term interpretation could be the contextual score minus the context-independent score. In some embodiments, the context-independent and contextual scores are combined using multiplication or division. For example, the overall score for a candidate multiple-term interpretation could be the contextual score divided by the context-independent score.

In an exemplary embodiment, the context-independent and contextual scores for a candidate multiple-term interpretation are combined to obtain an overall score by dividing the contextual score by the context-independent score plus 1. Following the previous example, if the query is tigt, paants, then the context-independent score is 2 and the contextual score is 30, so the overall score for the candidate multiple-term interpretation tight, pants is 30÷(2+1)=10.

The above examples represent some of the possible ways of combining the context-independent and contextual scores for candidate single-term interpretations to obtain an overall score for a candidate multiple-term interpretation. Other methods could also be used to compute this combination. The data driven and context-independent scores may be combined using, for example, addition, multiplication, or other arithmetic operations.

As indicated in step 26, the overall scores can be used to identify one or more optimal multiple-term interpretations. The scores can be used to rank the plausibility of the candidate multiple-term interpretations. The candidate multiple-term interpretation with the best overall score is the best candidate multiple-term interpretation.

In some embodiments of the present invention, an inverted index is used to map each term (i.e., potential single-term interpretation) to a set of documents in the database associated with that term. Preferably, this inverted index is used to compute contextual scores for multiple-term interpretations, e.g., by computing the intersection of the sets of documents associated with each of the single-term interpretations that comprise the multiple-term interpretation. An inverted index may also be used to compute context-independent scores for single-term interpretations. For example, if the context-independent score for a single-term interpretation considers the number of documents associated with that single-term interpretation, this number may be obtained from an inverted index. In some embodiments of the present invention, an index may be used to map terms to related terms, such as those obtained from a thesaurus. An inverted index may be implemented using a hash table, a B-tree, or other data structures familiar to those skilled in the art of building such data representations. The present invention may be used in a number of applications and may be implemented in a number of ways. The method of the present-invention is preferably a computer-implemented method. The method may be implemented, for example, on a query server in conjunction with a database server. The method may be implemented using, for example, software or firmware, which may be provided on or be run from a magnetic or optical disk, card, memory, or other storage medium.

In some embodiments of the present invention, the query processing system is a subsystem of an information retrieval application. In some embodiments, the candidate interpretations of a user query may be used to transform the user's query. For example, the query tigt, pants may be replaced with tight, pants if the latter is determined to be a better interpretation than the query itself. In some embodiments, the candidate interpretations of a user query may be used to suggest possible variations of the user's query. For example, the query tigt, pants may elicit a response of “Did you mean: tight, pants” if the latter is determined to be a plausible interpretation of the query.

The foregoing description has been directed to specific embodiments of the invention. The invention may be embodied in other specific forms without departing from the spirit and scope of the invention. The embodiments, figures, terms and examples used herein are intended by way of reference and illustration only and not by way of limitation. The scope of the invention is indicated by the appended claims and all changes that come within the meaning and scope of equivalency of the claims are intended to be embraced therein.

1. A method of interpreting a query formed of at least a first term and a second term with respect to a database of items, comprising:
identifying at least one candidate single-term interpretation for the first term;
identifying at least one candidate single-term interpretation for the second term;
identifying one or more candidate multiple-term interpretations, wherein a candidate multiple-term interpretation is a combination of candidate single-term interpretations;
providing a plurality of semantic approaches for associating one or more of the candidate multiple-term interpretations with items in the database; and
determining a contextual score for each candidate multiple-term interpretation using the database and at least one of said semantic approaches.

2. The method of claim 1, wherein the plurality of semantic approaches include treating a candidate multiple-term interpretation as a conjunction.

3. The method of claim 1, wherein the plurality of semantic approaches include treating a candidate multiple-term interpretation as a disjunction.

4. The method of claim 1, wherein the plurality of semantic approaches include partially matching a candidate multiple-term interpretation.

5. The method of claim 1, wherein the plurality of semantic approaches include a disjunctive approach, a conjunctive approach and a partial match approach.

6. The method of claim 1, wherein for at least one candidate multiple-term interpretation the contextual score incorporates information about the semantic approach that is used.

7. The method of claim 6, wherein incorporating information about the semantic approach includes using a measure of the number of terms in the candidate multiple-term interpretation that are in an associated result set.

8. The method of claim 7, wherein using a measure of the number of terms in the candidate multiple-term interpretation that are in an associated result set is a dominant factor in determining a contextual score.

9. The method of claim 1, wherein determining a contextual score for each candidate multiple-term interpretation includes using a first of said plurality of semantic approaches for identifying an associated result set for a first candidate multiple-term interpretation and a second of said plurality of semantic approaches for identifying an associated result set for a second candidate multiple-term interpretation.

10. The method of claim 1, wherein determining a contextual score for each candidate multiple-term interpretation includes applying a first of said plurality of semantic approaches for identifying a first associated result set and a second of said plurality of semantic approaches for identifying a second associated result set for a first candidate multiple-term interpretation and selecting between the first of said plurality of semantic approaches and the second of said plurality of semantic approaches for determining the contextual score for the first candidate multiple-term interpretation.

11. A method of interpreting a query formed of at least a first term and a second term with respect to a database of items, comprising:
identifying at least one candidate single-term interpretation for the first term;
identifying at least one candidate single-term interpretation for the second term;
pruning the candidate single-term interpretations;
identifying one or more candidate multiple-term interpretations, wherein a candidate multiple-term interpretation is a combination of candidate single-term interpretations that have not been pruned; and
determining a contextual score for each candidate multiple-term interpretation using the database.

12. The method of claim 11, wherein pruning includes eliminating each candidate single-term interpretation to which insufficient items in the database correspond.

13. The method of claim 12, wherein eliminating each candidate single-term interpretation to which insufficient items in the database correspond comprises generating a query that identifies a maximal result set of the candidate single-term interpretations, evaluating an intersection query for each candidate single-term interpretation with the maximal result set to identify results for the intersection query, and eliminating each candidate single-term interpretation for which the intersection query yields fewer results than a threshold.

14. The method of claim 13, wherein the threshold is 1.

15. The method of claim 12, wherein pruning includes determining a maximal result set of the candidate single-term interpretations.

16. The method of claim 12, wherein eliminating each candidate single-term interpretation to which insufficient items in the database correspond includes identifying results of a union of all of the potential candidate multiple-term interpretations, and eliminating candidate single-term interpretations that do not have associated items in the results of the union.

17. The method of claim 12, wherein eliminating each candidate single-term interpretation to which insufficient items in the database correspond includes identifying results of a union of all of the potential candidate multiple-term interpretations, and eliminating candidate single-term interpretations that have fewer associated items in the results of the union than a threshold.

18. The method of claim 11, further comprising determining a context-independent score for each candidate single-term interpretation, wherein pruning includes using the context-independent scores of the candidate single term interpretations for selecting candidate single-term interpretations to prune.

19. A computer program product, residing on a computer readable medium, for use in interpreting queries composed of at least a first term and a second term relative to a database of items, the computer program product comprising instructions for causing a computer to:
identify at least one candidate single-term interpretation for the first term;
identify at least one candidate single-term interpretation for the second term;
identify one or more candidate multiple-term interpretations, wherein a candidate multiple-term interpretation is a combination of candidate single-term interpretations;
provide a plurality of semantic approaches for associating candidate multiple-term interpretations with items in the database; and
determine a contextual score for each candidate multiple-term interpretation using the database and at least one of said semantic approaches.

20. The computer program product of claim 19, wherein for at least one candidate multiple-term interpretation the contextual score incorporates information about the semantic approach that is used.

21. The computer program product of claim 19, wherein the plurality of semantic approaches include a conjunctive approach.

22. The computer program product of claim 19, wherein the plurality of semantic approaches include a disjunctive approach.

23. The computer program product of claim 19, wherein the plurality of semantic approaches include a partial match approach.

24. The computer program product of claim 19, wherein the plurality of semantic approaches include a disjunctive approach, a conjunctive approach and a partial match approach.

25. The computer program product of claim 19, wherein instructions for causing a computer to incorporate information about the semantic approach used include instructions for using a measure of the number of terms in the candidate multiple-term interpretation that are in an associated result set.

26. The computer program product of claim 25, wherein using a measure of the number of terms in the candidate multiple-term interpretation that are in an associated result set is a dominant factor in determining a contextual score.

27. The computer program product of claim 19, wherein instructions for causing a computer to determine a contextual score for each candidate multiple-term interpretation include instructions for using a first of said plurality of semantic approaches for identifying an associated result set for a first candidate multiple-term interpretation and a second of said plurality of semantic approaches for identifying an associated result set for a second candidate multiple-term interpretation.

28. The computer program product of claim 19, wherein instructions for causing a computer to determine a contextual score for each candidate multiple-term interpretation include instructions for applying a first of said plurality of semantic approaches for identifying a first associated result set and a second of said plurality of semantic approaches for identifying a second associated result set for a first candidate multiple-term interpretation and selecting between the first of said plurality of semantic approaches and the second of said plurality of semantic approaches for determining the contextual score for the first candidate multiple-term interpretation.

29. A computer program product, residing on a computer readable medium, for use in interpreting queries composed of at least a first term and a second term relative to a database of items, the computer program product comprising instructions for causing a computer to:
identify at least one candidate single-term interpretation for the first term;
identify at least one candidate single-term interpretation for the second term;
prune the candidate single-term interpretations;
identify one or more candidate multiple-term interpretations, wherein a candidate multiple-term interpretation is a combination of candidate single-term interpretations that have not been pruned; and
determine a contextual score for each candidate multiple-term interpretation using the database.

30. The computer program product of claim 29, wherein instructions for causing a computer to prune include instructions for eliminating each candidate single-term interpretation to which insufficient items in the database correspond.

31. The computer program product of claim 30, wherein eliminating each candidate single-term interpretation to which insufficient items in the database correspond further includes generating a query that identifies a maximal result set of the candidate single-term interpretations, evaluating an intersection query for each candidate single-term interpretation with the maximal result set to identify results for the intersection query, and eliminating each candidate single-term interpretation for which the intersection query yields fewer results than a threshold.

32. The computer program product of claim 31, wherein the threshold is 1.

33. The computer program product of claim 30, wherein instructions for causing a computer to prune include instructions for determining a maximal result set of the candidate single-term interpretations.

34. The computer program product of claim 30, wherein eliminating each candidate single-term interpretation to which insufficient items in the database correspond includes identifying results of a union of all of the potential candidate multiple-term interpretations, and eliminating candidate single-term interpretations that do not have associated items in the results of the union.

35. The computer program product of claim 30, wherein eliminating each candidate single-term interpretation to which insufficient items in the database correspond includes identifying results of a union of all of the potential candidate multiple-term interpretations, and eliminating candidate single-term interpretations that have fewer associated items in the results of the union than a threshold.

36. The computer program product of claim 30, wherein instructions for causing a computer to prune include instructions for using the context-independent scores for selecting single-term interpretations to prune.

37. A method of interpreting a query formed of at least a first term and a second term with respect to a database of items, comprising:
identifying at least one candidate single-term interpretation for the first term;
identifying at least one candidate single-term interpretation for the second term;
determining a context-independent score for each candidate single-term interpretation;
identifying one or more candidate multiple-term interpretations, wherein a candidate multiple-term interpretation is a combination of candidate single-term interpretations;
determining a combined context-independent score for each candidate multiple-term interpretation using the context-independent score for each candidate single-term interpretation in the candidate multiple-term interpretation;
providing a plurality of semantic approaches for associating one or more of the candidate multiple-term interpretations with items in the database;
determining a contextual score for each candidate multiple-term interpretation using the database and at least one of said semantic approaches, wherein for at least one candidate multiple-term interpretation the contextual score incorporates information about the semantic approach that is used; and
determining an overall score for each candidate multiple-term interpretation by using the contextual score and the combined context-independent score for the multiple-term interpretation.

38. A method of interpreting a query formed of at least a first term and a second term with respect to a database of items, comprising:
identifying at least one candidate single-term interpretation for the first term;
identifying at least one candidate single-term interpretation for the second term;
determining a context-independent score for each candidate single-term interpretation;
pruning the candidate single-term interpretations;
identifying one or more candidate multiple-term interpretations, wherein a candidate multiple-term interpretation is a combination of candidate single-term interpretations that have not been pruned;
determining a combined context-independent score for each candidate multiple-term interpretation using the context-independent score for each candidate single-term interpretation in the multiple-term interpretation;
determining a contextual score for each candidate multiple-term interpretation using the database; and
determining an overall score for each candidate multiple-term interpretation by using the contextual score and the combined context-independent score for the multiple-term interpretation.

39. A computer program product, residing on a computer readable medium, for use in interpreting queries composed of at least a first term and a second term relative to a database of items, the computer program product comprising instructions for causing a computer to:
identify at least one candidate single-term interpretation for the first term;
identify at least one candidate single-term interpretation for the second term;
determine a context-independent score for each candidate single-term interpretation;
identify one or more candidate multiple-term interpretations, wherein a candidate multiple-term interpretation is a combination of candidate single-term interpretations;
determine a combined context-independent score for each candidate multiple-term interpretation using the context-independent score for each candidate single-term interpretation in the multiple-term interpretation;
provide a plurality of semantic approaches for associating candidate multiple-term interpretations with items in the database;
determine a contextual score for each candidate multiple-term interpretation using the database and at least one of said semantic approaches, wherein for at least one candidate multiple-term interpretation the contextual score incorporates information about the semantic approach that is used; and
determine an overall score for each candidate multiple-term interpretation by using the contextual score and the combined context-independent score for the multiple-term interpretation.

40. A computer program product, residing on a computer readable medium, for use in interpreting queries composed of at least a first term and a second term relative to a database of items, the computer program product comprising instructions for causing a computer to:
identify at least one candidate single-term interpretation for the first term;
identify at least one candidate single-term interpretation for the second term;
determine a context-independent score for each candidate single-term interpretation;
prune the candidate single-term interpretations;
identify one or more candidate multiple-term interpretations, wherein a candidate multiple-term interpretation is a combination of candidate single-term interpretations that have not been pruned;
determine a combined context-independent score for each candidate multiple-term interpretation using the context-independent score for each candidate single-term interpretation in the multiple-term interpretation;
determine a contextual score for each candidate multiple-term interpretation using the database; and
determine an overall score for each candidate multiple-term interpretation by using the contextual score and the combined context-independent score for the multiple-term interpretation.
